(19) United States
(12) Patent Application Publication
(10) Pub. No.: US 2025/0183260 A1
(43) Pub. Date: Jun. 5, 2025

(54) ANODES AND ANODE STRUCTURES

(71) Applicant: APPLE INC., Cupertino, CA (US)

(72) Inventors: Martin BETTGE, Mountain View, CA (US); Shawn W SNYDER, Santa Cruz, CA (US); Connor D BURKE, Santa Clara (S)

(21) Appl. No.: 18/967,047

(22) Filed: Dec. 3, 2024

Related U.S. Application Data
(60) Provisional application No. 63/606,318, filed on Dec. 5, 2023.

(51) Int. Cl. H01M 4/134; H01M 4/02; H01M 4/04; H01M 4/1395; H01M 4/66; H01M 10/0525; H01M 10/0585; H01M 10/42

(52) U.S. Cl. CPC H01M 4/134; H01M 4/0404; H01M 4/1395; H01M 4/661; H01M 4/662; H01M 10/0525; H01M 10/0585; H01M 10/4235; H01M 2004/021; H01M 2004/027

(57) ABSTRACT

Anodes including a plating layer and a lithium plated layer, and optionally a support layer, capping layer, and bonding layer, are described.

### PRIORITY

This patent application claims the benefit of U.S. Provisional Patent Application No. 63/606,318, entitled “ANODES AND ANODE STRUCTURES,” filed on Dec. 5, 2023, which is incorporated herein by reference in its entirety.

### FIELD

This disclosure relates generally to batteries, and more particularly, to anodes and anode structures for lithium-ion batteries.

### BACKGROUND

A commonly used type of rechargeable battery is a lithium battery, such as a lithium-ion or lithium-polymer battery. As battery-powered devices become increasingly small and more powerful, batteries powering these devices need to store more energy in a smaller volume.

There is a need for a dense, uniform, thin lithium films. Further, there is a need to produce a uniform current distribution in a lithium battery cell. Stacked designs having a conventional rough film or foil do not provide the support for a uniform lithium film, as their surface is rough and can fracture, dissolve, and expose Li.

### SUMMARY

In a first aspect, the disclosure is directed to an anode including a plating layer and a lithium layer uniformly plated on the plating layer.

In a second aspect, the anode can include a support layer disposed on the plating layer on the opposite side of the lithium layer. The anode can further include a capping layer disposed on the support layer on the opposite side of the plating layer. Still further, the anode can include a bonding layer disposed on the capping layer on the opposite side of the support layer.

In a third aspect, the support layer and capping layer are optional; the plating layer can be directly attached to the bonding layer.

In a fourth aspect, the disclosure is directed to a battery stack including a first battery cell stacked onto a second battery cell. The cathode of the first battery cell is connected via the bonding layer of the second battery cell. The first and second battery cells can be the same or different.

In a fifth aspect, the anode can be covered by a Li layer acting as cap layer. The lithium layer can be disposed on the surface of the plating layer, for example by sputtering, electron beam deposition, or chemical vapor deposition, or hot pressing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a top-down view of a battery cell in accordance with an illustrative embodiment;

FIG. 2 is a side view of a set of layers for a battery cell, in accordance with an illustrative embodiment;

FIG. 3 depicts an example of an anode stack, in accordance with an illustrative embodiment;

FIG. 4 depicts an example of another anode stack, in accordance with an illustrative embodiment;

FIG. 5 describes an example of an anode stack in accordance with an illustrative embodiment;

FIG. 6 describes an example of an anode stack in accordance with an illustrative embodiment; and

FIG. 7 depicts a battery stack formed of multiple batteries in accordance with an illustrative embodiment.

### DETAILED DESCRIPTION

The following description is presented to allow any person skilled in the art to make and use the embodiments, and is provided in the context of a particular application. Various modifications to the disclosed embodiments will be readily apparent to those skilled in the art, and the general principles defined herein may be applied to other embodiments and applications without departing from the spirit and scope of the present disclosure. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims. Thus, the disclosure is not limited to the embodiments shown, but is to be accorded the widest scope consistent with the principles and features disclosed herein.

As used herein, all compositions referenced for cathode active materials represent those of as-prepared materials (i.e., “virgin” materials) unless otherwise indicated. Materials of these compositions have not yet been exposed to additional processes, such as de-lithiation and lithiation during, respectively, charging and discharging of a lithium-ion battery.

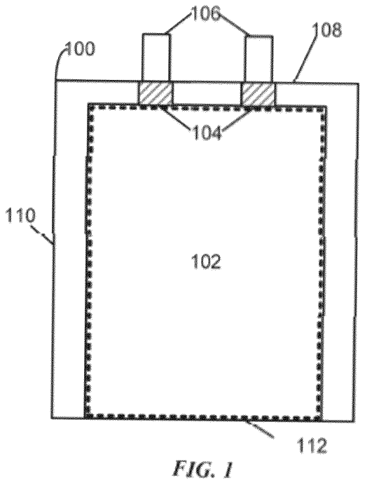

FIG. 1 presents a top-down view of a battery cell 100 in accordance with an embodiment. The battery cell 100 may correspond to a lithium-ion or lithium-polymer battery cell that is used to power a device used in a consumer, medical, aerospace, defense, and/or transportation application. The battery cell 100 includes a stack 102 containing a number of layers that include a cathode, a separator, and an anode. The stack 102 also includes a separator disposed between the cathode and anode. The cathode, anode, and separator layers may be left flat in a planar configuration.

Battery cells can be enclosed, for example in a flexible pouch or a hard case. Returning to FIG. 1, during assembly of the battery cell 100, the stack 102 can be enclosed in a pouch. The pouch can be flexible or rigid. The stack 102 may be in a planar configuration, although other configurations are possible. If flexible, the pouch can be formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a terrace seal 108. In some variations, the flexible pouch may be less than 120 microns thick to improve the packaging efficiency of the battery cell 100, the density of battery cell 100, or both.

The stack 102 also includes a set of conductive tabs 106 coupled to the cathode and the anode. The conductive tabs 106 may extend through seals in the pouch (for example, formed using sealing tape 104) to provide terminals for the battery cell 100. The conductive tabs 106 may then be used to electrically couple the battery cell 100 with one or more other battery cells to form a battery pack.

Batteries can be combined in a battery pack in any configuration. For example, the battery pack may be formed by coupling the battery cells in a series, parallel, or a series-and-parallel configuration. Such coupled cells may be enclosed in a hard case to complete the battery pack, or may be embedded within an enclosure of a portable electronic device, such as a laptop computer, tablet computer, mobile phone, personal digital assistant (PDA), digital camera, and/or portable media player.

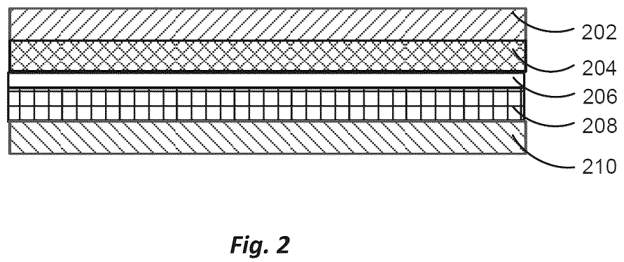

FIG. 2 presents a side view of a set of layers for a first battery cell (e.g., the battery cell 100 of FIG. 1) in accordance with the disclosed embodiments. The set of layers may include a cathode current collector 202, a cathode active material 204, a separator 206, an anode active material 208, and an anode current collector 210. The cathode current collector 202 and the cathode active material 204 form a cathode for the battery cell, and the anode current collector 210 and the anode active material 208 form an anode for the battery cell. To create the battery cell, the set of layers may be stacked in a planar configuration.

As mentioned above, the cathode current collector 202 may be aluminum foil, the cathode active material 204 may be a lithium compound, the anode current collector 210 may be copper foil, and the separator 206 may include a conducting polymer electrolyte.

It will be understood that the cathode active materials described herein can be used in conjunction with any battery cells or components thereof known in the art. For example, the layers may be stacked and/or used to form other types of battery cell structures, such as bi-cell structures. All such battery cell structures are known in the art.

The disclosure is directed to anodes including a plating layer onto which is plated a lithium layer. The anode can include three optional layers: a support layer, a capping layer, and a bonding layer. The optional layers are configured to impart additional properties to the anode, depending on the properties of the plating layer.

The metal electrode stack allows plating, mechanically support, and encapsulation of lithium films that can be used in rechargeable electrochemical devices. Several properties can confer advantages to over other anodes. Chiefly, the anode can be used in battery cells without a liquid electrolyte. Further, the anode allows the battery cell to be configured such that battery cells can be stacked to allow current flow in the z-direction. The anode is mechanically robust and compliant to plated lithium film. The anode is chemically and mechanically compliant to ion-conducting membrane. In some variations, the anode can have a low surface or interface roughness to promote uniform current density. The battery cell further provides the ability to reversibly pass at least once Li-ions from Li-ion source through to the metal stack in both z-directions.

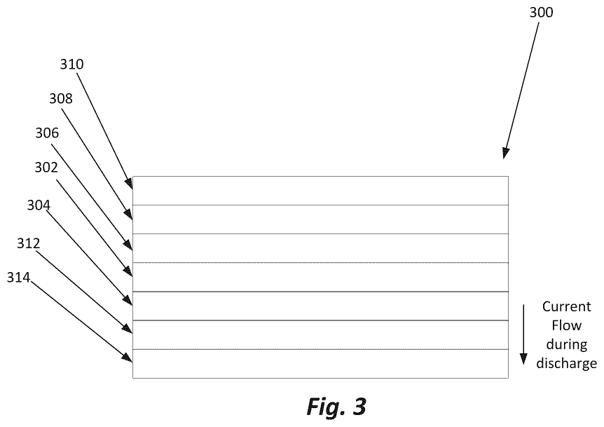

FIG. 3 depicts an example of an anode stack 300. Anode stack 300 includes plating layer 302 onto which is plated lithium layer 304. The opposite side of plating layer 302 is disposed support layer 306. Capping layer 308 is disposed on support layer 306. Bonding layer 310 is disposed on capping layer 308. Current flows in the z-direction, through an ion-conducting layer 312 to and from the lithium-ion source 314. Because current flows in the direction shown in the z-direction during discharge, battery cells to be stacked one upon the other via bonding layer 310.

Likewise, the ion-conducting layer can be any such layer known in the art. Specifically, the ion-conducting layer can be a liquid, solid, semi-solid, or composite electrolyte material/substance. Any conventional electrolyte can be considered in this invention.

### Plating Layer

The plating layer is a lithium receiving layer in contact with Li-ion-conducting layer. The plating layer is electrically conductive.

In some variations, the plating layer can be selected from one of the materials including Li, Cu, Ti, Zr, Al, Nb, V, Mo, Cr, La, Ca, Zn, Sb, Ta, Hf, Mg, TiAl, TiAlN, C, and Ni. The plating layer can also include an alloy of one or more of these elements. Any one of the described materials can be selected.

In some instances, the plating layer comprises Cu. Because Li diffuses through Cu when plated, Cu may include a cap layer described herein. In some instances, Cu does not include a cap layer. The Cu layer can further include a support layer due to its low yield strength relatives to TiAl.

The plating layer is disposed on an ion-conducting layer where Li is plated onto the interface. In some instances, the plating layer is disposed on an ion-conducting layer, plate the Li onto the interface, after which the plating layer lifts plating layer off the ion-conducting layer.

In some instances, the plating layer comprises Ni. Because Li diffuses through Cu when plated, the anode includes a cap layer when the plate layer is formed of Ni.

In some instances, the plating layer comprises Ti. Because Li diffuses through Cu when plated, the anode includes a cap layer when the plate layer is formed of Ti.

In some variations, the plating layer has an average thickness of at least 10 nm. In some variations, the plating layer has an average thickness of at least 50 nm. In some variations, the plating layer has an average thickness of at least 100 nm. In some variations, the plating layer has an average thickness of at least 500 nm. In some variations, the plating layer has an average thickness of at least 1 km. In some variations, the plating layer has an average thickness of at least 5 km. In some variations, the plating layer has an average thickness of at least 10 km. In some variations, the plating layer has an average thickness of at least 15 km.

In some variations, the plating layer has an average thickness of less than or equal to 20 μm. In some variations, the plating layer has an average thickness of less than or equal to m. In some variations, the plating layer has an average thickness of less than or equal to 10 m. In some variations, the plating layer has an average thickness of less than or equal to 5 km. In some variations, the plating layer has an average thickness of less than or equal to 1 μm. In some variations, the plating layer has an average thickness of less than or equal to 500 nm. In some variations, the plating layer has an average thickness of less than or equal to 100 nm. In some variations, the plating layer has an average thickness of less than or equal to 50 nm.

The lower and upper boundaries can be combined in any combination described herein.

### Lithium Layer

Lithium is plated on the plating layer. The lithium can be plated uniformly. “Uniform plating” means that the lithium layer on the surface of the plating layer has a lithium thickness within 20% variation over the entirety of the lithium layer. In some variations, the lithium layer on the surface of the plating layer has a lithium thickness within 10% variation over the entirety of the lithium layer.

The lithium layer can be disposed on the plating layer by any method known in the art. In some non-limiting methods, lithium can be sputtered onto the plating layer, added to the plating layer by electron beam deposition or chemical vapor deposition, or hot pressing of lithium onto an ion-conducting layer. The lithium layer can have a smooth, uniform interface with ion-conducting membrane.

In some variations, the lithium layer can be manufactured as the plating layer. In such instances, the lithium plating layer includes a support layer or capping layer. If the lithium layer acts as a capping layer only, it includes plating and plating and support layer having different material composition.

In some variations, the lithium layer has thickness with a lower boundary, thickness with an upper boundary, or a combination of both.

In some variations, the lithium layer has an average thickness of at least 10 nm. In some variations, the lithium layer has an average thickness of at least 50 nm. In some variations, the lithium layer has an average thickness of at least 100 nm. In some variations, the lithium layer has an average thickness of at least 500 nm. In some variations, the lithium layer has an average thickness of at least 1 μm. In some variations, the lithium layer has an average thickness of at least 5 μm. In some variations, the lithium layer has an average thickness of at least 10 μm. In some variations, the lithium layer has an average thickness of at least 20 μm. In some variations, the lithium layer has an average thickness of at least 30 μm. In some variations, the lithium layer has an average thickness of at least 40 km.

In some variations, the lithium layer has an average thickness of less than or equal to 50 μm. In some variations, the lithium layer has an average thickness of less than or equal to m. In some variations, the lithium layer has an average thickness of less than or equal to 30 m. In some variations, the lithium layer has an average thickness of less than or equal to 10 km. In some variations, the lithium layer has an average thickness of less than or equal to 5 μm. In some variations, the lithium layer has an average thickness of less than or equal to 1 μm. In some variations, the lithium layer has an average thickness of less than or equal to 500 nm. In some variations, the lithium layer has an average thickness of less than or equal to 100 nm. In some variations, the lithium layer has an average thickness of less than or equal to 50 nm.

The lower and upper boundaries can be combined in any combination described herein.

### Support Layer

An optional support layer can be provided adjacent to the plating layer. The support layer provides mechanical support and rigidity to the underlying plating layer. The support layer is electronically conductive, allowing current to flow in the in the z-direction.

The mechanical support can result from increased thickness. Use of thinner support layers increase energy density.

In various aspects, the support layer is selected from Cu, Ti, Zr, Al, Nb, V, Mo, Cr, La, Ca, Zn, Sb, Ta, Hf, Mg, TiAl, and TiAlN. Any one of the referenced materials can be selected. The support layer can also include an alloy of one or more of these elements.

In some variations, the support layer is formed of Nb. In some variations, the support layer is formed of V. In some variations, the support layer is formed of Mo.

In some variations, the support layer has an average thickness of at least 10 nm. In some variations, the support layer has an average thickness of at least 50 nm. In some variations, the support layer has an average thickness of at least 100 nm. In some variations, the support layer has an average thickness of at least 500 nm. In some variations, the support layer has an average thickness of at least 1 μm. In some variations, the support layer has an average thickness of at least 100 μm. In some variations, the support layer has an average thickness of at least 500 m. In some variations, the support layer has an average thickness of at least 100 μm. In some variations, the support layer has an average thickness of at least 1 mm. In some variations, the support layer has an average thickness of at least 1.5 mm.

In some variations, the support layer has an average thickness of less than or equal to 2 mm. In some variations, the support layer has an average thickness of less than or equal to 1.5 mm. In some variations, the support layer has an average thickness of less than or equal to 1 mm. In some variations, the support layer has an average thickness of less than or equal to 10 μm. In some variations, the support layer has an average thickness of less than or equal to 5 μm. In some variations, the support layer has an average thickness of less than or equal to 1 μm. In some variations, the support layer has an average thickness of less than or equal to 500 nm. In some variations, the support layer has an average thickness of less than or equal to 100 nm. In some variations, the support layer has an average thickness of less than or equal to 50 nm.

The lower and upper boundaries of the support layer can be combined in any combination described herein.

### Support Layer Optionality

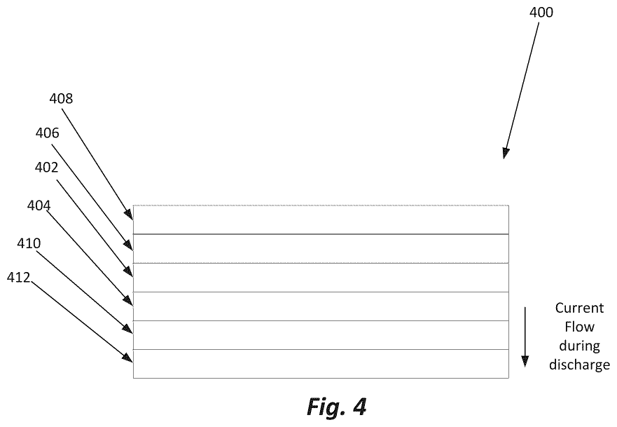

In variations where the plating layer has a sufficiently high yield strength to serve as a layer for both plating and support, a separate support layer is optional, or does not have to be included. FIG. 4 depicts an example of another anode stack 400. Anode stack 400 includes plating layer 402, onto which is plated lithium layer 404. The opposite side of plating layer 402 is disposed capping layer 406. Bonding layer 408 is disposed on capping layer 406. As with other anodes described herein, current flows in the z-direction through the ion-conducting layer 410 to and from the lithium-ion source 412, allowing battery cells to be stacked one upon the other.

In certain anode variations, such as when the plating layer has sufficient mechanical yield strength (e.g., TiAl) to support a lithium layer, a support layer may not be included (FIG. 4). In instances in which a plating layer does not have sufficient mechanical support (e.g., Ni or Cu), a support layer can be included to provide mechanical support. In some variations, the tensile yield strength is at least 20 MPa. In some variations, the tensile yield strength is at least 25 MPa. In some variations, the tensile yield strength is at least 30 MPa. In some variations, the tensile yield strength is at least 35 MPa. In some variations, the tensile yield strength is at least 40 MPa.

In some specific variations, the plating layer is TiAl. When TiAl is used, additional support and capping layers are optional because TiAl can perform functions of plating and support. In one instance, the plating layer comprises a TiAl alloy. TiAl is non-diffusive and has 20 times the yield strength of Cu alone. As such, TiAl can be used without a separate support layer.

### Capping Layer

An optional capping layer can be disposed on the support layer. The capping layer can provide chemical resistance to Li ion migrating through that stack and to Li reacting with the bond layer or the current collector. The capping layer can be used in instances where the support layer is a material that allows Li migration. The capping layer limits or prevents Li migration beyond the capping layer. Like other layers, the capping layer is electronically conductive, allowing current to flow in the z-direction.

In various aspects, the capping layer is a chemically inert material to Li. For example, the capping layer is selected from Ni, Ti, Zr, Nb, V, Mo, Cr, La, TiAl, TiAlN, and Li. Any one of the referenced materials can be selected. In some particular examples, the capping layer is formed of TiAlN. The capping layer can also include an alloy of one or more of these elements.

If Li is used a cap layer, it could also act as a bond layer. The Li can react intentionally with the bond layer without affecting the amount of Li plated on the plating layer (or Li as a plating layer). in and uniformity of the (plated) lithium layer

In some variations, the capping layer has an average thickness of at least 10 nm. In some variations, the capping layer has an average thickness of at least 50 nm. In some variations, the capping layer has an average thickness of at least 100 nm. In some variations, the capping layer has an average thickness of at least 500 nm. In some variations, the capping layer has an average thickness of at least 1 μm. In some variations, the capping layer has an average thickness of at least 5 μm. In some variations, the capping layer has an average thickness of at least 10 μm.

In some variations, the capping layer has an average thickness of less than or equal to 20 μm. In some variations, the capping layer has an average thickness of less than or equal to 10 μm. In some variations, the capping layer has an average thickness of less than or equal to 5 μm. In some variations, the capping layer has an average thickness of less than or equal to 1 μm. In some variations, the capping layer has an average thickness of less than or equal to 500 nm. In some variations, the capping layer has an average thickness of less than or equal to 100 nm. In some variations, the capping layer has an average thickness of less than or equal to 50 nm.

The lower and upper boundaries can be combined in any combination described herein.

### Capping Layer Optionality

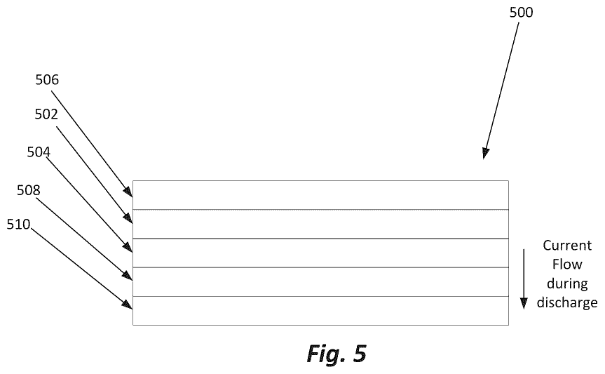

In some instances, a support layer and capping layer are not required, such as when the plating layer has sufficient strength not to include a support layer, and the plating and support layers do not allow diffusion of lithium through the plating layer. The plating layer can be attached directly to the bonding layer. FIG. 5 describes an example of an anode stack in which a neither a support layer nor capping layer is used. Anode stack 500 includes plating layer 502 onto which is plated lithium layer 504. Bonding layer 506 is disposed on plating layer 502. As with other anodes described herein, current flows in the z-direction through the ion-conducting layer 508 to and from the lithium-ion source 510, allowing battery cells to be stacked one upon the other.

### Bonding Layer

In some variations, the anode optionally can include a bonding layer. The bonding layer can bond a battery to an adjacent battery cell. The electrode stack can be bonded to a current collector, secondary cell, or other component.

The bonding layer is an electronically conductive material. In some variations, the melting point of the material is less than 400° C. Examples of such materials include In, Sn, and alloys containing In/Sn, Ga/Sn, Ga/In, Ga/Zn, Bi/Sn, Bi/In, Sn/Ag/Cu, or Bi/Sn/In. Any one of the materials can be selected. In some variations, the alloy includes Sn/In. Terms separated by / refer to an alloy that is the combination of those elements (e.g., Sn/In refers to an alloy of Sn and In.) In other variations, the bond layer can be a conductive polymer, a conductive adhesive, or a conductive paste (e.g., a sintering copper paste.)

In some variations, the thickness of the bonding layer can have a lower limit, an upper limit, or both. In some variations, the thickness is at least 10 nm. The bonding layer can be from 10 nm to 20 μm.

In some variations, the bonding layer has an average thickness of at least 10 nm. In some variations, the bonding layer has an average thickness of at least 50 nm. In some variations, the bonding layer has an average thickness of at least 100 nm. In some variations, the bonding layer has an average thickness of at least 500 nm. In some variations, the bonding layer has an average thickness of at least 1 μm. In some variations, the bonding layer has an average thickness of at least 5 μm. In some variations, the bonding layer has an average thickness of at least 10 μm.

In some variations, the bonding layer has an average thickness of less than or equal to 20 μm. In some variations, the bonding layer has an average thickness of less than or equal to 10 μm. In some variations, the bonding layer has an average thickness of less than or equal to 5 μm. In some variations, the bonding layer has an average thickness of less than or equal to 1 μm. In some variations, the bonding layer has an average thickness of less than or equal to 500 nm. In some variations, the bonding layer has an average thickness of less than or equal to 100 nm. In some variations, the bonding layer has an average thickness of less than or equal to 50 nm.

### Bonding Layer Optionality

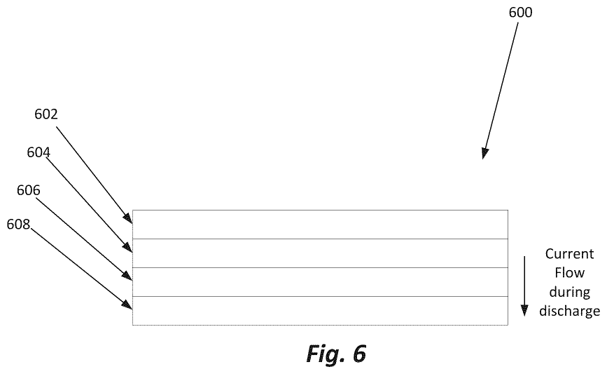

In some instances, a bonding layer is not included, such as when the battery cell is not built into a battery stack. FIG. 6 describes one such example of an anode stack in which only a plating layer is used. Anode stack 600 includes plating layer 602 onto which is plated lithium layer 604. As with other anodes described herein, current flows in the z-direction through the ion-conducting layer 606 to and from the lithium-ion source 608, allowing battery cells to be stacked one upon the other.

### Battery Stacks

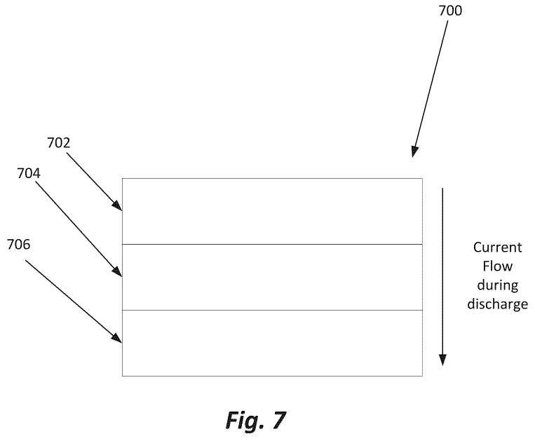

Multiple battery cells can be built into a battery stack. FIG. 7 depicts battery stack 700 including battery cells 702, 704, and 706. Because the battery cells are designed for current to flow in the z-direction without the use of tabs, the battery stack does not require any additional components to allow current outside the end-to-end geometry of the battery stacks.

The anodes described herein can be valuable in battery cells, including those used in electronic devices and consumer electronic products. An electronic device herein can refer to any electronic device known in the art. For example, the electronic device can be a telephone, such as a cell phone, and a land-line phone, or any communication device, such as a smart phone, including, for example an iPhone®, an electronic email sending/receiving device. The electronic device can also be an entertainment device, including a portable DVD player, conventional DVD player, Blue-Ray disk player, video game console, music player, such as a portable music player (e.g., iPod®), etc. The electronic device can be a part of a display, such as a digital display, a TV monitor, an electronic-book reader, a portable web-browser (e.g., iPad®), watch (e.g., AppleWatch), or a computer monitor. The electronic device can also be a part of a device that provides control, such as controlling the streaming of images, videos, sounds (e.g., Apple TV®), or it can be a remote control for an electronic device. Moreover, the electronic device can be a part of a computer or its accessories, such as the hard drive tower housing or casing, laptop housing, laptop keyboard, laptop track pad, desktop keyboard, mouse, and speaker. The anode cells, lithium-metal batteries, and battery packs can also be applied to a device such as a watch or a clock.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

We claim:

1. An anode comprising:
a plating layer; and
a lithium layer uniformly plated on the plating layer.

2. The anode of claim 1, wherein the plating layer is formed of a material selected from Li, Cu, Ti, Zr, Al, Nb, V, Mo, Cr, La, Ca, Zn, Sb, Ta, Hf, Mg, TiAl, TiAlN, Ni, C, and an alloy of any of the foregoing.

3. The anode of claim 1, wherein the plating layer is formed of TiAl.

4. The anode of claim 1, consisting of:
the plating layer formed of TiAl;
the lithium layer disposed on the plating layer; and
a bonding layer disposed on the plating layer on the opposite side of the lithium layer.

5. The anode of claim 1, wherein the plating layer has an average thickness of 10 nm-20 μm.

6. The anode of claim 1, wherein lithium layer has an average thickness of 10 nm-50 μm.

7. The anode of claim 1, comprising a support layer disposed on the plating layer on the opposite side of the lithium layer.

8. The anode of claim 7, wherein the support layer is formed of a material selected from Li, Cu, Ti, Zr, Al, Nb, V, Mo, Cr, La, Ca, Zn, Sb, Ta, Hf, Mg, TiAl, TiAlN, Ni, and an alloy of any of the foregoing.

9. The anode of claim 7, wherein the support layer is formed of a material selected from Nb, V, and Mo.

10. The anode of claim 7, wherein the plating layer is formed of Ni.

11. The anode of claim 7, wherein the support layer has an average thickness of 10 nm-2 mm.

12. The anode of claim 7, comprising a capping layer disposed on the support layer on the opposite side of the plating layer.

13. The anode of claim 12, wherein the capping layer is formed of a material selected from Ni, Ti, Zr, Nb, V, Mo, Cr, La, TiAl, TiAlN, Li, and an alloy of any of the foregoing.

14. The anode of claim 12, wherein the capping layer is formed of TiAlN.

15. The anode of claim 12, wherein the capping layer has an average thickness of 10 nm-20 μm.

16. The anode of claim 12, comprising a bonding layer disposed on the capping layer on the opposite side of the support layer.

17. The anode of claim 16, wherein the bonding layer is formed of a material selected from In, Sn, In/Sn, Ga/Sn, Ga/In, Ga/Zn, Bi/Sn, Bi/In, Sn/Ag/Cu, and Bi/Sn/In.

18. The anode of claim 16, wherein the bonding layer is formed of In/Sn.

19. The anode of claim 16, wherein the bonding layer has an average thickness of 10 nm-20 μm.

20. An anode comprising:
a plating layer comprising lithium;
a support layer disposed on a first surface of the plating layer; and
a capping layer disposed on the support layer opposite the lithium layer.

21. A battery cell comprising
the anode of claim 1;
an ion-conducting layer on the opposite side of the lithium layer from the plating layer; and
a lithium source on the opposite side of the ion-conducting layer from the lithium layer.

22. A battery stack comprising:
a first battery cell of claim 21; and
a second battery cell of claim 21,
wherein the lithium source of the first battery cell is connected to the bonding layer of the second battery cell, and
wherein the first battery cell and second battery cell are the same or different.

23. A method of manufacturing an anode according to claim 1, comprising:
disposing the lithium layer on the surface of the plating layer.

24. The method of claim 23, wherein the lithium layer is disposed on the plating layer by sputtering, electron beam deposition, or chemical vapor deposition.

25. The method of claim 23, wherein the lithium layer is disposed on the ion-conducting layer by hot pressing.
